(19) United States
(12) Patent Application Publication
(10) Pub. No.: US 2014/0143964 A1
(43) Pub. Date: May 29, 2014

(54) REFILL HEAD FOR AN ORAL CARE IMPLEMENT HANDLE

(71) Applicant: Joseph E. Fattori, East Sandwich, MA (US)

(72) Inventor: Joseph E. Fattori, East Sandwich, MA (US)

(73) Assignee: Colgate-Palmolive Company, New York, NY (US)

(21) Appl. No.: 14/232,256

(22) PCT Filed: Feb. 3, 2012
(86) PCT No.: PCT/US2012/023780

§ 371 Date: Jan. 11, 2014

Related U.S. Application Data
(60) Provisional application No. 61/506,986, filed on Jul. 12, 2011.

(51) Int. Cl. A61C 17/22; A61C 17/34

(52) U.S. Cl. CPC A61C 17/222; A61C 17/3481
USPC 15/22.1; 15/145; 15/167.1

(57) ABSTRACT

A refill head, and oral care implement incorporating the same, wherein the refill head can be uncoupled from a stem of a handle by compressing a portion of a tubular sleeve of the refill head radially inward, therby retracting a locking lug of the refill head radially outward

### CROSS-REFERENCE TO RELATED APPLICATIONS

The present application claims the benefit of U.S. Provisional Patent Application No. 61/506,986, filed on Jul. 12, 2011, the content of which is hereby incorporated by reference in its entirety.

### FIELD OF THE INVENTION

The present invention relates generally to refill heads for oral care implements, and specifically to the coupling structure of the refill head.

### BACKGROUND OF THE INVENTION

Powered toothbrushes having replaceable heads, commonly referred to as refill heads, are known in the art. Such powered toothbrushes typically include a handle and a refill head that is detachably coupled to the handle. The replaceability of the heads in such powered toothbrushes is desirous because the handle, which includes the motion-inducing circuitry and components, is expensive to manufacture and has a much longer life expectancy than do the tooth cleaning elements, such as the bristles, that are on the refill head. Consumers would not be willing to pay a premium to purchase such powered toothbrushes if they had to be discarded when the bristles or other cleaning elements wore out. Thus, it is now standard in the industry to provide refill heads that can be attached and detached from the handle so that worn out refill heads can be replaced as needed for the same handle.

Existing refill heads suffer from a number of deficiencies, including complexity of manufacture, the ability to improperly load the refill head to the handle, and inadequate coupling of the refill head to the handle. Thus, a need exists for a refill head having an improved coupling structure.

### BRIEF SUMMARY OF THE INVENTION

The present invention is directed to a refill head, and oral care implement incorporating the same, wherein the refill head can be uncoupled from a stem of a handle by compressing a portion of a tubular sleeve of the refill head radially inward, thereby retracting a locking lug of the refill head radially outward.

In one embodiment, the invention can be a toothbrush comprising: a handle comprising: a gripping portion; and a stem extending from the gripping portion, the stem extending along an axis, the stem comprising first and second locking lugs extending radially outward from an outer surface of the stem, the first and second locking lugs arranged in a circumferentially spaced apart manner; and a refill head detachably coupled to the handle, the refill head comprising: a head portion comprising a plurality of tooth cleaning elements; a tubular sleeve coupled to the head portion, the tubular sleeve having a cavity in which the stem is disposed, the tubular sleeve comprising first and second resilient zones that are compressible radially inward, the first and second resilient zones circumferentially spaced apart from one another; a resilient collar located within the cavity in transverse alignment with the first and second resilient zones and coupled to the tubular sleeve, the resilient collar comprising first and second locking lugs extending radially inward from an inner surface of the resilient collar, the first and second locking lugs of the resilient collar radially aligned with the first and second locking lugs of the stem respectively; and wherein compressing the first and second resilient zones of tubular sleeve radially inward alters the resilient collar from: (1) a locked state in which the locking lugs of the resilient collar operably mate with the first and second locking lugs; to (2) an unlocked state in which the locking lugs of the resilient collar are retracted radially outward and out of operable mating with the locking lugs of the stem.

In another embodiment, the invention can be a refill head comprising: a head portion; a tubular sleeve coupled to the head portion, the tubular sleeve having a cavity for receiving a stem of a handle and extending along an axis, the tubular sleeve comprising at least one resilient zone that is compressible radially inward; a resilient collar located within the cavity in transverse alignment with the resilient zone and coupled to the tubular sleeve, the resilient collar comprising at least one locking lug extending radially inward from an inner surface of the resilient collar; and wherein compressing the resilient zone of the tubular sleeve radially inward retracts the locking lug of the resilient collar radially outward from the axis.

In yet another embodiment, the invention can be a refill head comprising: a head portion; a tubular sleeve coupled to the head portion, the tubular sleeve having a cavity for receiving a stem of a handle and extending along an axis; at least one locking lug extending radially inward from an inner surface of the tubular sleeve; and wherein compressing a portion of the tubular sleeve radially inward retracts the locking lug radially outward from the axis.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front view of a refill head and a toothbrush handle in alignment for detachable coupling according to one embodiment of the present invention, wherein the refill head and the handle are shown in one-quarter longitudinal cross-section;

FIG. 2 is a longitudinal one-quarter cross-sectional view of the refill head according to one embodiment of the present invention;

FIG. 3 is a left-side view of a proximal portion of the tubular sleeve of FIG. 1 illustrating one of the resilient zones;

FIG. 4 is a transverse cross-sectional view of the toothbrush of FIG. 5 taken along view IV-IV, wherein the resilient collar is in a locked state;

FIG. 4A is a transverse cross-sectional view of the toothbrush of FIG. 5 taken along view IV-IV, wherein the resilient collar is in an un-locked state due to the resilient zones of the tubular sleeve being compressed radially inward;

FIG. 5 is one-quarter longitudinal cross-sectional view of the refill head and the toothbrush handle of FIG. 1 detachably coupled together according to one embodiment of the present invention, taken along view V-V of FIG. 4; and

FIG. 6 is a transverse cross-sectional view of the toothbrush of FIG. 5 taken along view VI-VI, wherein the indexing feature of the toothbrush is exemplified.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

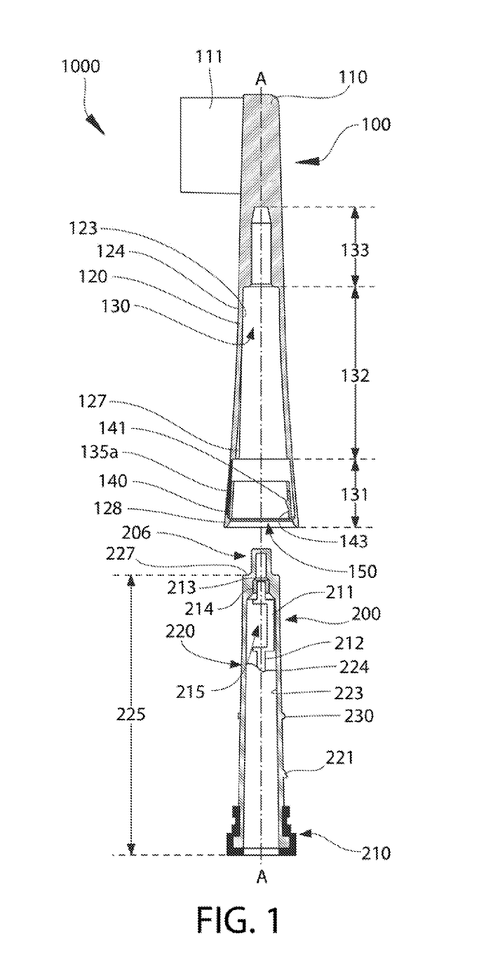

Referring to FIGS. 1 and 5 concurrently, a powered toothbrush 1000 according to one embodiment of the present invention is illustrated. The powered toothbrush 1000 generally comprises a refill head 100 and a handle 200. The powered toothbrush 1000 generally extends along a longitudinal axis A-A. As discussed in greater detail below, the refill head 100 and the handle 200 are designed so that the refill head 100 can be repetitively coupled to and uncoupled from the handle 200. In FIG. 1, the powered toothbrush 1000 is illustrated in a state wherein the refill head 100 is not coupled to the handle 200 but is positioned in axial alignment with the handle 200 so that such coupling can be effectuated. In FIG. 5, the powered toothbrush 1000 is illustrated in a state wherein the refill head 100 is coupled to the handle 200 according to an embodiment of the present invention.

While the invention is exemplified herein as a powered toothbrush 1000, it is to be understood that the inventive concepts discussed herein can be applied to manual toothbrushes that utilize refill heads, or other manual or powered oral care implements, including without limitation tongue cleaners, water picks, interdental devices, tooth polishers and specially designed ansate implements having tooth engaging elements.

Referring now to FIGS. 1, 3 and 5 concurrently, the handle 200 will be described in greater detail. The handle 200 generally comprises a gripping portion 210 (only a small portion of which is exemplified) and a stem 220. The stem 220 extends from the gripping portion 210 along the longitudinal axis A-A.

The gripping portion 210 of the handle 200 is an elongated structure that provides the mechanism by which a user can hold and manipulate the toothbrush 1000 during use. The gripping portion 210 can take on a wide variety of shapes, contours and configurations, none of which are limiting of the present invention. Although not illustrated herein, it should be understood that included within the gripping portion 210 is a power source, a motor and electrical circuitry and components necessary to create a desired motion within the refill head 100. In the exemplified embodiment, the desired motion is a vibratory motion. The vibratory motion is imparted to the refill head via a vibratory element, such as an eccentric 211, that is located within the stem 220 and that is rotated via operable coupling to the motor. The gripping portion 210 also includes a user interface that controls the various operations of the toothbrush 1000, including without limitation turning off and on, changing speeds of the motor, or other functions. The gripping portion 210, in essence, forms a watertight housing for the aforementioned electrical circuit and mechanical components that need to be protected from moisture.

In the exemplified embodiment, the motion to be transmitted to the head portion 110 of the refill head 100 is a vibratory motion. In order to generate such vibratory motion, the handle 200 comprises a vibratory element, which in the exemplified embodiment is in the form of an eccentric 211 coupled to a drive shaft 212. A proximal portion (not illustrated) of the drive shaft 212 is operably coupled to the electric motor (not illustrated) so that the electric motor can rotate the drive shaft 212. A distal portion 213 of the drive shaft 212 is retained by an annular bearing 214 which is mounted within the stem 220. As the drive shaft 212 is rotated, the eccentric 211, due to its off-center center of gravity, generates vibrations that are transmitted to the stem 220 and to the refill head 100 (discussed in greater detail below). While the eccentric 211 is exemplified as a portion of the drive shaft 212 that is radially offset from the longitudinal axis A-A, the invention is not so limited. In other embodiments, the eccentric 211 may be an offset disc or other offset weight, as is known in the art. As can be seen in FIG. 1, the stem 220 forms a watertight housing having an internal cavity 215 in which the drive shaft 212 and eccentric 211 are housed. Additional details of a suitable vibratory producing handle, and related structure that can be incorporated into the powered toothbrush 1000 of the present invention, can be found in U.S. Patent Application Publication No. 2010/0269275, Shimoyama et al., published Oct. 28, 2010 (filed as U.S. patent application Ser. No. 12/377,355), the entirety of which is hereby incorporated by reference.

Referring to FIGS. 1 and 4-6, the stem 220 of the handle 200 will be described in greater detail. The stem 220 comprises an inner surface 223 and an outer surface 224. Furthermore, the stem 220 comprises a base portion 225 and an alignment plug 226. The alignment plug 226 extends from a distal end 227 of the base portion 225. As noted above, the stem 220 extends from the gripping portion 210 along the longitudinal axis A-A. The stem 220 is an elongated structure that has a coupling structure that enables the refill head 100 to be repetitively coupled to and uncoupled from the handle 200. Specifically, the stem 220 comprises a first locking lug 221 and a second locking lug 222. In the exemplified embodiment, the first and second locking lugs 221, 222 are located on the base portion 225 of the stem 220. However, the invention is not to be so limited and the first and second locking lugs 221, 222 can be otherwise positioned on the stem 220 as desired.

Each of the first and second locking lugs 221, 222 extends radially outward from the outer surface 224 of the stem 220. Furthermore, the first and second locking lugs 221, 222 are arranged on the outer surface 224 of the stem 220 in a circumferentially spaced apart manner. In certain embodiments, the first and second locking lugs 221, 222 are spaced 180° apart. However, the invention is not to be so limited and the first and second locking lugs 221, 222 can be spaced apart at other angles of circumferential spacing in alternate embodiments.

The stem 220 further includes a flange 230 extending from the outer surface 224. The flange 230 comprises an axial slot 231 formed therein. The flange 230 and axial slot 231 are configured for maintaining relative rotational orientation between the handle 200 and the refill head 100 as will be described in detail below. Stated simply, it is an indexing feature.

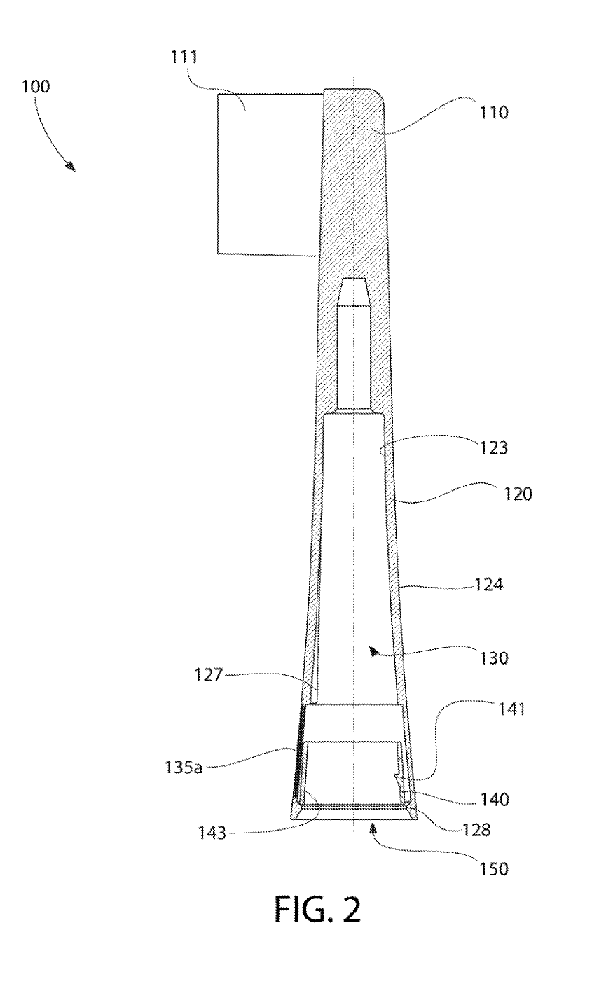

Referring now to FIGS. 1, 2 and 5 concurrently, the refill head 100 will be described in greater detail. As noted above, the refill head 100 is capable of being detachably coupled to the handle 200 so that the refill head 100 can be replaced with a new refill head when it becomes worn out and/or no longer effectively cleans a user's teeth and/or other oral surfaces. By enabling the powered toothbrush 1000 to have refill heads 100 that can be detachably coupled to the handle 200, the entire powered toothbrush 1000 does not need to be replaced when the tooth engaging elements 111 on the refill head 100 become worn out.

The refill head 100 generally comprises a head portion 110 and a tubular sleeve 120 that is coupled to the head portion 110. In the exemplified embodiment, the tubular sleeve 120 and the head portion 110 of the refill head 100 are integrally formed as a single unitary structure using a molding, milling, machining or other suitable process. However, in other embodiments the head portion 110 and the tubular sleeve 120 of the refill head 100 may be formed as separate components which are operably connected at a later stage of the manufacturing process by any suitable technique known in the art, including without limitation thermal or ultrasonic welding, a tight-fit assembly, a coupling sleeve, threaded engagement, adhesion, or fasteners.

The head portion 110 of the refill head 100 comprises a collection of oral cleaning elements such as tooth cleaning elements 111 extending therefrom for cleaning and/or polishing contact with an oral surface and/or interdental spaces. In the exemplified embodiment, the tooth cleaning elements 111 are generically illustrated. While the collection of tooth cleaning elements 111 is suited for brushing teeth, the collection of tooth cleaning elements 111 can also be used to polish teeth instead of or in addition to cleaning teeth. As used herein, the term “tooth cleaning elements” is used in a generic sense to refer to any structure that can be used to clean, polish or wipe the teeth and/or soft oral tissue (e.g. tongue, cheek, gums, etc.) through relative surface contact. Common examples of “tooth cleaning elements” include, without limitation, bristle tufts, filament bristles, fiber bristles, nylon bristles, spiral bristles, rubber bristles, elastomeric protrusions, flexible polymer protrusions, combinations thereof and/or structures containing such materials or combinations. Suitable elastomeric materials include any biocompatible resilient material suitable for uses in an oral hygiene apparatus. To provide optimum comfort as well as cleaning benefits, the elastomeric material of the tooth or soft tissue engaging elements has a hardness property in the range of A8 to A25 Shore hardness. One suitable elastomeric material is styrene-ethylene/butylene-styrene block copolymer (SEBS) manufactured by GLS Corporation. Nevertheless, SEBS material from other manufacturers or other materials within and outside the noted hardness range could be used.

The tooth cleaning elements 111 of the present invention can be connected to the refill head 100 in any manner known in the art. For example, staples/anchors, in-mold tufting (IMT) or anchor free tufting (AFT) could be used to mount the tooth cleaning elements. In AFT, a plate or membrane is secured to the brush head such as by ultrasonic welding. The bristles extend through the plate or membrane. The free ends of the bristles on one side of the plate or membrane perform the cleaning function. The ends of the bristles on the other side of the plate or membrane are melted together by heat to be anchored in place. Any suitable form of cleaning elements may be used in the broad practice of this invention. Alternatively, the bristles could be mounted to tuft blocks or sections by extending through suitable openings in the tuft blocks so that the base of the bristles is mounted within or below the tuft block.

The tubular sleeve 120 comprises an inner surface 123 and an outer surface 124. The inner surface 123 of the tubular sleeve 120 defines a cavity 130. When the refill head 100 is detachably coupled to the handle 200 in accordance with the present invention, the stem 220 of the handle 200 is disposed within the cavity 130. The cavity 130 comprises a proximal axial section 131, a middle axial section 132 and a distal axial section 133. The proximal axial section 131 of the cavity 130 includes an opening 150 for receiving the stem 220 of the handle 200. Thus, the opening 150 forms a passageway into the cavity 130. The middle axial section 132 tapers from the proximal axial section 131 to the distal axial section 133. The distal axial section 133 has a narrowed transverse cross-sectional profile relative to the proximal and middle axial sections 131, 132.

The tubular sleeve 120 and the head portion 110 of the refill head 100 are generally formed of a material that is rigid, such as a moldable hard plastic. Suitable hard plastics include polymers and copolymers of ethylene, propylene, butadiene, vinyl compounds and polyesters such as polyethylene terephthalate. Of course, the invention is not to be so limited and other materials can be used to form the tubular sleeve 120 and head portion 110 of the refill head 100.

Referring to FIGS. 1-5 concurrently, the tubular sleeve 120 further comprises a first resilient zone 135a and a second resilient zone 135b. Each of the first and second resilient zones 135a, 135b is formed by sealing an aperture 129a, 129b in the tubular sleeve 120 with a resilient material. The resilient material that forms the first and second resilient zones 135a, 135b can be an elastomeric material, such as a suitable thermoplastic elastomer (TPE) or other similar materials used in oral care products. The elastomeric material of the first and second resilient zones 135a, 135b may have a hardness durometer measurement ranging between A13 to A50 Shore hardness, although materials outside this range may be used so long as the first and second resilient zones 135a, 135b can be compressed as described herein below. A suitable range of the hardness durometer rating is between A25 to A40 Shore hardness. Of course, the invention is not limited to having resilient zones 135a, 135b formed as described above and in other embodiments the resilient zones 135a, 135b can be formed by simply thinning out (or otherwise pre-weakening) regions of the tubular sleeve 120 so that those regions of the tubular sleeve 120 are compressible.

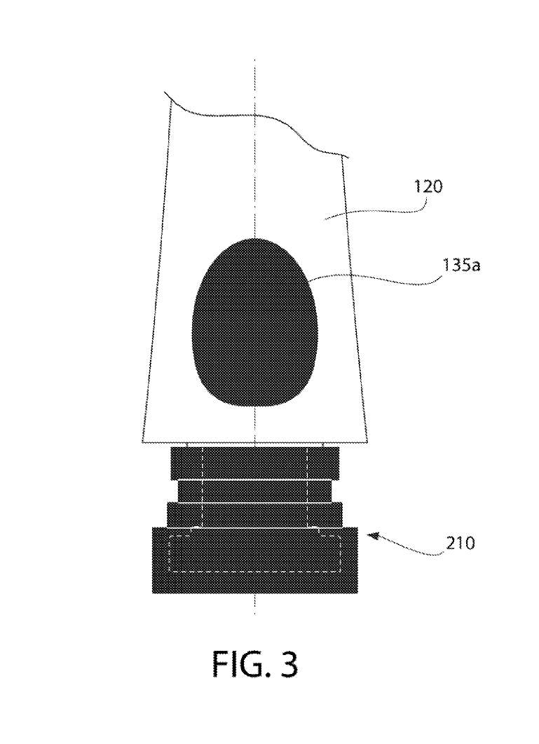

The first and second resilient zones 135a, 135b are circumferentially spaced apart from one another along the circumference of the tubular sleeve 120. As can be seen in FIG. 3, in the exemplified embodiment, each of the resilient zones 135a, 135b takes on a generally elliptical shape. However, the invention is not to be so limited and, in other embodiments, the resilient zones 135a, 135b can take on other shapes as desired. The first and second resilient zones 135a, 135b are capable of being compressed radially inwardly in order to facilitate coupling and uncoupling of the refill head 100 to the handle 200 (described in greater detail below). Due to the resilient nature of the first and second resilient zones 135a, 135b, even when the first and second resilient zones 135a, 135b are compressed radially inward, the first and second apertures 1291, 129b remain sealed by the resilient material.

The tubular sleeve 120 comprises an axial rib 127 that protrudes inwardly from the inner surface 123 of the tubular sleeve 120. During coupling of the refill head 100 to the handle 200, the axial rib 127 mates with the axial slot 231 in the flange 230 of the stem 220. As a result, the inner surface 123 of the tubular sleeve 120 and the outer surface 224 of the stem 220 are keyed in order to maintain relative rotational orientation between the stem 220 and the tubular sleeve 120.

The refill head 100 further comprises a resilient collar 140 that is positioned within the cavity 130. More specifically, the resilient collar 140 is located within the cavity 130 in transverse alignment with the first and second resilient zones 135a, 135b. The resilient collar 140 is preferably formed of a deformable thermoplastic material, such as polypropylene. While thermoplastics, such as polypropylene, are typically considered rigid or hard plastics, the thickness of the resilient collar 140 is selected so that the resilient collar 140 has the desired degree of compressibility and resiliency. In other words, by balancing the material selected and its thickness, the resilient collar 140 can be constructed so as to sufficiently rigid from a structural standpoint to axially retain the stem 220 within the cavity 130 while still allowing for the required resiliency for locking and unlocking.

During assembly, the resilient collar 140 is placed into the bottom of the tubular sleeve 120 and then snap fitted therein. More specifically, the resilient collar 140 is positioned within the proximal axial section 131 of the cavity 130 of the tubular sleeve 120 of the refill head 100. The resilient collar 140 comprises a first locking lug 141 and a second locking lug 142 extending radially inward into the cavity 130 from an inner surface 143 of the resilient collar 140. The first and second locking lugs 141, 142 are circumferentially spaced apart from one another. As discussed in greater detail below, when the refill head 100 is detachably coupled to the handle 200, the first and second locking lugs 141, 142 of the resilient collar 140 are radially aligned with and operably mate with the first and second locking lugs 221, 222 of the stem 220, respectively.

The tubular sleeve 120 comprises an annular retaining flange 128 protruding inwardly towards the cavity 130 from the inner surface 123 of the tubular sleeve 120. The annular retaining flange 128 axially retains the resilient collar 140 in position within the tubular sleeve 120. The annular retaining flange 128 protrudes inwardly towards the cavity 130, thereby preventing axial removal of the resilient collar 140 from the tubular sleeve 120.

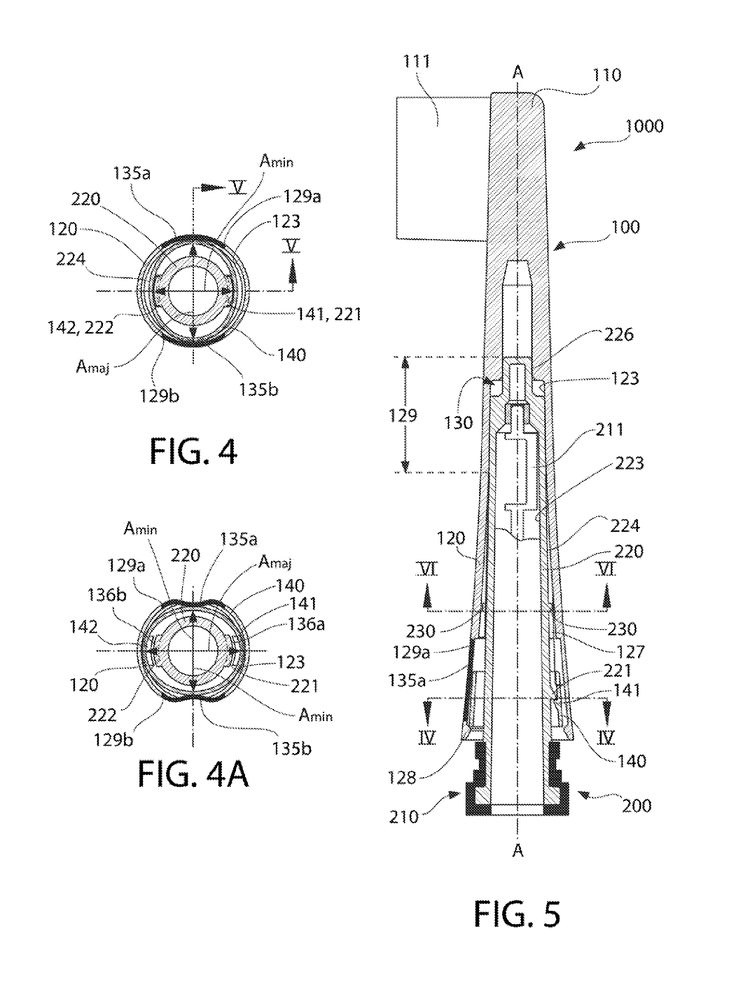

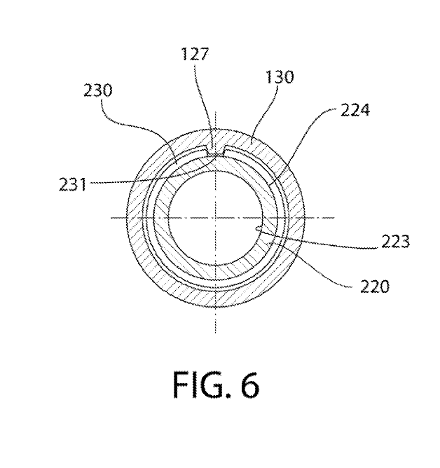

Referring to FIGS. 4-6 concurrently, the coupling and uncoupling of the refill head 100 to the handle 200 will be described. When it is desired to attach the refill head 100 to the handle 200, the refill head 100 is positioned above and in axial alignment with the handle 200. The handle 200 is then axially translated so that the stem 220 begins to be inserted into the cavity 130. If necessary, the handle 200 is then rotated relative to the refill head 100 until the axial rib 127 comes into alignment with the axial slot 231 that is formed in the flange 230 of the stem 220. As can be seen in FIG. 6, upon the axial rib 127 mating with the axial slot 231, the desired relative rotational orientation between the stem 220 and the tubular sleeve 120 is achieved and maintained. Aligning the axial rib 127 with the axial slot 231 formed in the flange 230 of the stem 220 also ensures that the first and second locking lugs 141, 142 of the resilient collar 140 are radially aligned with the first and second locking lugs 221, 222 of the stem 220 during the coupling of the refill head 100 to the handle 200. Such radial alignment facilitates the locking of the refill head 100 to the handle 200 during assembly.

After alignment of the axial rib 127 with the axial slot 231 is achieved, the stem 220 continues to be inserted into the cavity 130 by axially translating (i.e., sliding) the stem 220 into the cavity 130 of the refill head 100. As a result, the first and second locking lugs 141, 142 of the resilient collar 140 are forced to flex outwardly and snap past the first and second locking lugs 221, 222 of the stem 220, thereby achieving a locked state. Thus, insertion of the stem 220 into the cavity 130 automatically achieves locking engagement between the refill head 100 and the handle 200 because the resilient collar 140 is biased into the locked state. FIG. 4 illustrates the locking engagement between the first and second locking lugs 141, 142 of the resilient collar 140 and the first and second locking lugs 221, 222 of the stem 220.

Referring to FIGS. 1 and 5 concurrently, the structural arrangement of the powered toothbrush 1000 when the refill head 100 is detachably coupled to the handle 200 will be described. When the refill head 100 is coupled to the handle 200, the alignment plug 226 of the stem 220 extends into the distal axial section 133 of the cavity 130. Furthermore, when the refill head 100 is coupled to the handle 200, only a distal section 229 of the outer surface 224 of the stem 220 is in intimate surface contact with the inner surface 123 of the tubular sleeve 120. By having the distal section 229 in surface contact with the inner surface 123 of the tubular sleeve 120, vibrations from the stem 220 can be transmitted directly to the refill head 100. It is advantageous to minimize the amount of the stem 220 that is in intimate contact with the inner surface 123 of the tubular sleeve 120 in order to prevent vibration from being transmitted to the handle 200. The loose fitting resilient collar 140 further facilities minimizing the contact between the stem 220 and the tubular sleeve 120 below the distal section 229 of the stem 220 to minimize vibration transmission to the handle 200 to maximize comfort to a user during use of the powered toothbrush 1000.

Referring to FIGS. 4, 4A and 5, unlocking the refill head 100 from the handle 200 so that the refill head 100 can be detached from the handle 200 will be described. When it is desired to separate or detach the refill head 100 from the handle 200, the first and second resilient zones 135a, 135b are compressed radially inwardly to alter the configuration (which in the exemplified embodiment is the shape of the transverse cross-sectional profile) of the resilient collar 140. Specifically, the biased state of the resilient collar 140 is a locked state (shown in FIG. 4) in which the first and second locking lugs 141, 142 of the resilient collar 140 operably mate with the first and second locking lugs 221, 222 of the stem 220 to prevent axial separation of the refill head 100 form the handle 200. When the first and second resilient zones 135a, 135b are compressed radially inwardly, the first and second resilient zones 135a, 135b press against the resilient collar 140. Due to the resiliency of the resilient collar 140, compressing the first and second resilient zones 135a, 135b alters the resilient collar 140 into the unlocked state (shown in FIG. 4A) in which the first and second locking lugs 141, 142 of the resilient collar 140 are retracted radially outward and out of operable mating with the first and second locking lugs 121, 122 of the stem 120. Once the first and second locking lugs 141, 142 of the resilient collar 140 are out of operable mating with the first and second locking lugs 121, 122 of the stem 120, the refill head 100 can be detached from the handle 200 by pulling the refill head 100 axially away from the handle 200.

The locking/unlocking feature of the resilient collar 140 is achievable in part due to the shape of the resilient collar 140. More specifically, the resilient collar 140 has an oval transverse cross-sectional profile in both the locked state and the unlocked state, wherein the oval transverse cross-sectional profile has a major axis Aₘₐⱼ and a minor axis Aₘᵢₙ. The major axis Aₘₐⱼ and the minor axis Aₘᵢₙ of the oval transverse cross-sectional profile of the resilient collar 140 change or swap direction/position depending upon whether the resilient collar 140 is in the locked or unlocked state.

The inner surface 123 of the tubular sleeve 120 has a circular transverse cross-sectional profile having a diameter that is substantially equal to a length of the major axis Aₘₐⱼ of the oval transverse cross-sectional profile of the resilient collar 140. Thus, a portion of the inner surface 123 of the tubular sleeve 120 is in contact with a portion of the resilient collar 140. Referring first to FIG. 4, in the locked state the resilient collar 140 has an oval transverse cross-sectional profile having a major axis Aₘₐⱼ that is in radial alignment with the first and second resilient zones 135a, 135b of the tubular sleeve 120 and a minor axis Aₘᵢₙ that is in radial alignment with the first and second locking lugs 121, 122 of the stem 120, the major axis being greater than the minor axis. Thus, in the locked state (FIG. 4) the portion of the inner surface 123 of the tubular sleeve 120 that is in contact with the resilient collar 140 is the first and second resilient zones 135a, 135b.

Because the first and second resilient zones 135a, 135b are in contact with the resilient collar 140 when the resilient collar 140 is in the locked state, compressing the first and second resilient zones 135a, 135b also results in compression of the resilient collar 140. More specifically, as a user compresses the first and second resilient zones 135a, 135b (and thus the resilient collar 140), the resilient collar 140 becomes altered from the locked state to the unlocked state. Altering the resilient collar 140 form the locked state to the unlocked state results in the transverse cross-sectional profile of the resilient collar 140 changing so that the major axis Aₘₐⱼ and the minor axis Aₘₐⱼ swap with one another. In other words, in the unlocked state (FIG. 4A), the transverse cross-sectional profile of the resilient collar 140 is modified to comprise a minor axis Aₘᵢₙ that is in radial alignment with the first and second resilient zones 135a, 135b of the tubular sleeve 120 and a major axis Aₘₐⱼ that is in radial alignment with the first and second locking lugs 121, 122 of the stem 120 due to the inward compression of the first and second resilient zones 135a, 135b of the tubular sleeve 120.

Thus, as the first and second resilient zones 135a, 135b are compressed, the resilient collar 140 is modified so that the major axis Aₘₐⱼ is aligned with the first and second locking lugs 141, 142. Changing the location of the major axis Aₘₐⱼ of the resilient collar 140 retracts the first and second locking lugs 141, 142 of the resilient collar 140 radially outward and away from the first and second locking lugs 121, 122 of the stem 120 in a direction transverse to the longitudinal axis A-A. This creates enough separation between the first and second locking lugs 141, 142 of the resilient collar 140 and the first and second locking lugs 121, 122 of the tubular sleeve 120, respectively so that a first gap 136a exists between the first locking lug 141 of the resilient collar 140 and the first locking lug 121 of the tubular sleeve 120 and a second gap 136b exists between the second locking lug 142 of the resilient collar 140 and the second locking lug 122 of the tubular sleeve 120. The first and second gaps 136a, 136b are substantially equal in width. Thus, compression of the first and second resilient zones 135a, 135b pulls the first and second locking lugs 141, 124 of the resilient collar 140 out of operable mating engagement with the first and second locking lugs 121, 122 of the tubular sleeve 120. The gaps 136a, 136b enable the refill head 100 to be detached from the handle 200 with an upward or axial pulling motion of the refill head 100 relative to the handle 200.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

While the foregoing description and drawings represent the exemplary embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A toothbrush comprising:
a handle comprising:
a gripping portion; and
a stem extending from the gripping portion, the stem extending along an axis, the stem comprising first and second locking lugs extending radially outward from an outer surface of the stem, the first and second locking lugs arranged in a circumferentially spaced apart manner; and
a refill head detachably coupled to the handle, the refill head comprising:
a head portion comprising a plurality of tooth cleaning elements;
a tubular sleeve coupled to the head portion, the tubular sleeve having a cavity in which the stem is disposed, the tubular sleeve comprising first and second resilient zones that are compressible radially inward, the first and second resilient zones circumferentially spaced apart from one another;
a resilient collar located within the cavity in transverse alignment with the first and second resilient zones and coupled to the tubular sleeve, the resilient collar comprising first and second locking lugs extending radially inward from an inner surface of the resilient collar, the first and second locking lugs of the resilient collar radially aligned with the first and second locking lugs of the stem respectively; and
wherein compressing the first and second resilient zones of tubular sleeve radially inward alters the resilient collar from: (1) a locked state in which the locking lugs of the resilient collar operably mate with the first and second locking lugs of the stem; to (2) an unlocked state in which the locking lugs of the resilient collar are retracted radially outward and out of operable mating with the locking lugs of the stem.

2. The toothbrush according to claim 1 wherein the first resilient zone comprises a first aperture in the tubular sleeve that is sealed with a resilient material, and the second resilient zone comprises a second aperture in the tubular sleeve that is sealed with the resilient material.

3. The toothbrush according to claim 2 wherein the resilient material is a thermoplastic elastomer and the tubular sleeve is formed of a hard plastic.

4. The toothbrush according to claim 1 wherein the resilient collar is axially retained within the cavity by an annular retaining flange protruding from an inner surface of the tubular sleeve.

5. The toothbrush according to claim 1 wherein in the locked state, the resilient collar has a transverse cross-sectional profile comprising a major axis in radial alignment with the first and second resilient zones of the tubular sleeve and a minor axis in radial alignment with the first and second locking lugs of the stem, the major axis being greater than the minor axis.

6. The toothbrush according to claim 5 wherein in the unlocked state, the transverse cross-sectional profile of the resilient collar is modified to comprise a minor axis in radial alignment with the first and second resilient zones of the tubular sleeve and a major axis in radial alignment with the first and second locking lugs of the stem due to the first and second resilient zones of the tubular sleeve being compressed radially inward.

7. The toothbrush according to claim 1 wherein the resilient collar has an oval transverse cross-sectional profile in both the locked state and the unlocked state, the oval transverse cross-sectional profile comprising a major axis and a minor axis.

8. The toothbrush according to claim 7 wherein the inner surface of the tubular sleeve has a circular transverse cross-sectional profile having a diameter that is substantially equal to the major axis of the oval transverse cross-sectional profile of the resilient collar.

9. The toothbrush according to claim 1 wherein the resilient collar is biased into the locked state.

10. The toothbrush according to claim 1 wherein the inner surface of the tubular sleeve and the outer surface of the stem are keyed to maintain relative rotational orientation between the stem and the tubular sleeve.

11. The toothbrush according to claim 10 wherein the stem comprises a flange extending from the outer surface of the stem and an axial slot formed in the flange, the tubular sleeve comprises an axial rib that mates with the axial slot to maintain relative rotational orientation between the stem and the tubular sleeve.

12. The toothbrush according to claim 1 wherein the first and second locking lugs of the stem are located on a base portion of the stem and the resilient collar is located in a proximal portion of the refill head.

13. The toothbrush according to claim 1 wherein the cavity of the tubular sleeve tapers from a proximal end of the cavity to a distal end of the cavity, the proximal end of the cavity having an opening for receiving the stem.

14. The toothbrush according to claim 1 wherein the handle comprises a power source and a vibratory element operably coupled to the power source.

15. The toothbrush according to claim 14 wherein the vibratory element is located within the stem.

16. The toothbrush according to claim 15 wherein only a distal section of the outer surface of the stem is in intimate surface contact with an inner surface of the tubular sleeve.

17. The toothbrush according to claim 1 wherein the cavity comprises a proximal axial section, a middle axial section, and a distal axial section, the resilient collar located within the proximal axial section, the stem comprising an alignment plug extending from a distal end of the stem that extends into the distal axial section, and wherein the middle axial section tapers from the proximal axial section to the distal axial section.

18. A refill head for an oral care implement, comprising:
a head portion;
a tubular sleeve coupled to the head portion, the tubular sleeve having a cavity for receiving a stem of a handle and extending along an axis, the tubular sleeve comprising at least one resilient zone that is compressible radially inward;
a resilient collar located within the cavity in transverse alignment with the resilient zone and coupled to the tubular sleeve, the resilient collar comprising at least one locking lug extending radially inward from an inner surface of the resilient collar; and
wherein compressing the resilient zone of the tubular sleeve radially inward retracts the locking lug of the resilient collar radially outward from the axis.

19. The refill head according to claim 18 wherein the resilient zone comprises a first aperture in the tubular sleeve that is sealed with a resilient material.

20. The refill head according to claim 19 wherein the resilient material is a thermoplastic elastomer and the tubular sleeve is formed of a hard plastic.

21. The refill head according to claim 18 wherein when the resilient zone of the tubular sleeve is not compressed radially inward, the resilient collar has a transverse cross-sectional profile comprising a major axis in radial alignment with the resilient zone of the tubular sleeve and a minor axis in radial alignment with the locking lug of the stem, the major axis being greater than the minor axis.

22. The refill head according to claim 21 wherein when the resilient zone of the tubular sleeve is compressed radially inward, the transverse cross-sectional profile of the resilient collar is modified to comprise a minor axis in radial alignment with the resilient zone of the tubular sleeve and a major axis in radial alignment with the locking lug of the stem.

23. The refill head according to claim 21 wherein the resilient collar is biased into a state in which the transverse cross-sectional profile comprises the major axis in radial alignment with the resilient zone of the tubular sleeve and the minor axis in radial alignment with the locking lug of the stem, the major axis being greater than the minor axis.

24. The refill head according to claim 18 wherein the resilient collar has an oval transverse cross-sectional profile and the tubular sleeve has a circular transverse cross-sectional profile.

25. The refill head according to claim 18 wherein the resilient collar is located in a proximal portion of the refill head.

26. The refill head according to claim 18 wherein the cavity of the tubular sleeve tapers from a proximal end of the cavity to a distal end of the cavity, the proximal end of the cavity having an opening for receiving the stem.

27. The refill head according to claim 18 wherein the cavity comprises a proximal axial section, a middle axial section, and a distal axial section, the resilient collar located within the proximal axial section, an annular shoulder located between the middle axial section and the distal axial section, and wherein the middle axial section tapers from the proximal section to the distal section.

28. A refill head for an oral care implement, comprising:
a head portion;
a tubular sleeve coupled to the head portion, the tubular sleeve having a cavity for receiving a stem of a handle and extending along an axis;
at least one locking lug extending radially inward from an inner surface of the tubular sleeve; and
wherein compressing a portion of the tubular sleeve radially inward retracts the locking lug radially outward from the axis.
